(19) United States
(12) Patent Application Publication
(10) Pub. No.: US 2020/0125342 A1
(43) Pub. Date: Apr. 23, 2020

(54) SELF-LEARNING BASED PREDICTIVE SECURITY REQUIREMENTS SYSTEM FOR APPLICATION RISK MANAGEMENT

(71) Applicant: CA, Inc., New York, NY (US)

(72) Inventors: Jacek Dominiak, Elblag (PL); Smrati Gupta, San Jose, CA (US); Victor Muntés-Mulero, Sant Feliu de Llobregat (ES); Peter Brian Matthews, Berkhamsted (GB); Oscar Enrique Ripolles Mateu, Barcelona (ES)

(21) Appl. No.: 16/165,906

(22) Filed: Oct. 19, 2018

(51) Int. Cl. G06F 8/41; G06N 5/02; G06F 8/35; G06F 8/10; G06F 8/73; G06F 15/18; G06F 8/60

(52) U.S. Cl. CPC G06F 8/433; G06F 8/49; G06N 5/022; G06F 8/60; G06F 8/10; G06F 8/73; G06F 15/18; G06F 8/35

(57) ABSTRACT

Systems and methods for application development include predicting a probable set of risks (e.g., security risks, financial risks, legal risks etc.) and risk mitigations for software development or deployment risk management. The system records user activity with respect to assigning risks and risk mitigations to application components. The system utilizes user inputs and characteristics of the modelled application as well as the user inputs and characteristics associated with past development and deployment of similar applications in order to predict a probable set of risks and/or risk mitigation actions.

### BACKGROUND

The disclosure generally relates to the field of information security, and more particularly to modeling, design, simulation, or emulation.

Risk assessment generally requires specialised domain knowledge across the information technology arena, as well as highly advanced security specific knowledge in the same domain. Performing a complete and reliable risk assessment process can impose high costs in terms of budget and resources. It is not merely the financial cost of a resource but the availability of resources with risk management skills that often relegates risk management to a poorly understood and poorly implemented part of any software application development and deployment.

Moreover, applications have become important components for businesses in many sectors. The technical complexity of software applications can increase the probability that some critical non-functional requirements might be missed in the risk assessment process for these applications. This aggravates the need for expert resources that can perform the risk assessment.

Many times, project goals focus on delivering new functionality upon each release. This emphasis decreases the visibility of risk management in a project. Further, the emphasis on delivering new functionality can potentially increases the opportunity for missed requirements, the difficulty in evaluating the risks and in selecting or designing the most suitable risk mitigation approach. Furthermore, the required expertise together with the lack of understanding of the prominence of risk management of results in rushing, or even omitting risk management for an application. The risk management process may, in many cases, be performed in absence of critical expertise leading to ineffective and inaccurate analysis. This is due to the fact that risk analysis is usually not considered a task of software developer, making the risk management process even more challenging.

### BRIEF DESCRIPTION OF THE DRAWINGS

Aspects of the disclosure may be better understood by referencing the accompanying drawings.

FIG. 1 is a block diagram illustrating a system for application risk management.

FIG. 2 is a block diagram illustrating data objects and linkages between data object in a system for application risk management.

FIG. 3 is a flow chart illustrating operations of a method for application risk management.

FIG. 4 is a diagram illustrating an example user choices model.

FIG. 5 is a diagram illustrating a user behavior model.

FIG. 6 illustrates an example user interface.

FIG. 7 depicts an example computer system providing at least a portion of a system for application risk management.

### DESCRIPTION

The description that follows includes example systems, methods, techniques, and program flows that embody aspects of the disclosure. However, it is understood that this disclosure may be practiced without these specific details. For instance, this disclosure refers to risks and risk mitigations in illustrative examples. Aspects of this disclosure can be applied to other attributes of applications such as performance aspects, resource usage aspects, business impact aspects such as trustworthiness, reputation, legal compliance etc. In other instances, well-known instruction instances, protocols, structures and techniques have not been shown in detail in order not to obfuscate the description.

Overview

A system for application development includes a predictor that can report a probable set of risks (e.g., security risks, financial risks, legal risks etc.) and risk mitigations for software development or deployment risk management. The system records user activity with respect to assigning risks and risk mitigations to application components. The system utilizes user inputs and characteristics of the modelled application as well as the user inputs and characteristics associated with past development and deployment of similar applications in order to predict a probable set of risks and/or risk mitigation actions.

The risks and risk mitigations can be based on a predefined set of possible risks and risk mitigations. For example, in some aspects, the risks can comprise security threats and security controls. The set of security threats and security controls can be based on a set of security threats defined by the National Institute of Standards and Technology (NIST) Cybersecurity Framework. The NIST framework includes the following families of security controls:

AC—Access Control

AU—Audit and Accountability

AT—Awareness and Training

CM—Configuration Management

CP—Contingency Planning

IA—Identification and Authentication

IR—Incident Response

MA—Maintenance

MP—Media Protection

PS—Personnel Security

PE—Physical and Environmental Protection

PL—Planning

PM—Program Management

RA—Risk Assessment

CA—Security Assessment and Authorization

SC—System and Communications Protection

SI—System and Information Integrity

SA—System and Services Acquisition

Each family has a set of particular security controls. The NIST framework includes a definition of the security control and a measuring technique on how the security control should be fulfilled. The individual controls within the above-identified families can be applied to various risks associated with application components.

Other application risk management frameworks can be used in addition to, or instead of, the NIST Cybersecurity Framework. Examples of such other frameworks include the STRIDE Threat Model developed by Microsoft Corporation; Operationally Critical Threat, Asset, and Vulnerability Evaluation (OCTAVE) methodology developed by the Software Engineering Institute of Carnegie Mellon University; and Open Web Application Security Project (OWASP). The embodiments are not limited to any particular risk definition and control framework.

### Example Illustrations

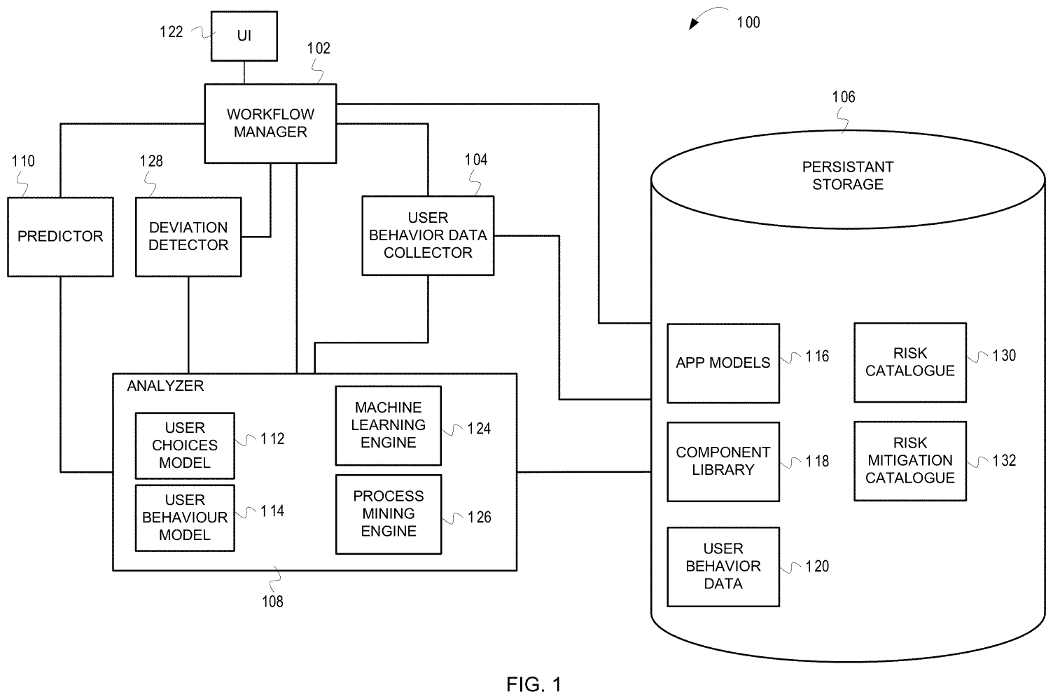

FIG. 1 is a block diagram illustrating a system 100 for application risk management. In some aspects, system 100 includes a workflow manager 102, a user behavior data collector 104, an analyzer 108, and a predictor 110. In some aspects, workflow manager 102 can maintain information regarding deployed software applications and applications under development. Software applications typically have multiple stages of development and typically undergo configuration changes during development. Workflow manager 102 can maintain information regarding the configuration of an application (e.g., the components used by or associated with an application and associated parameters), the current stage of development of an application (e.g., design, development, test, release version etc.), and risk assessments and mitigations associated with the components of an application. In some aspects, workflow manager 102 can include logic for communication with other modules of the system such as data collector 104, analyzer 108 and predictor 110. Further, a deviation detector 128 can optionally be included in system 100 and can communicate with the workflow manager 102 as described below.

Workflow manager 102 can include a user interface 122 that provides user interface elements that a user can utilize to interact with the system. For example, user interface 122 can provide user interface elements allowing a user to add and remove components of an application, configure the application and components of the application, associate risks and risk mitigation actions to applications and components etc. In some aspects, user interface 122 can represent a Kanban-style board utilized by members of a development team to visually assess the status and progress of an application and its components. As one example of a Kanban-style interface, user interface 122 can present a swimlane style dashboard that guides the user through the software development, deployment, and risk management process. Those of skill in the art having the benefit of the disclosure will appreciate that other styles of user interfaces can be utilized to maintain and present information about a software application during its development and deployment. Further, user interface 122 can present output generated by other modules of the system such as the analyzer 108, and predictor 110.

User behavior data collector 104 can collect information associated with actions performed by a user of the system. For example, when a user performs an action via user interface 122, the user behavior data collector 104 can receive an indication of the action, and collect information associated with the action. Examples of such information include inputs associated with the action (e.g., component type, name etc.), additions or changes to a set of risk characteristics for a component, indicators of additions and indicators of changes to risk mitigations associated with the risk characteristics for the component, and timestamps of the action. The indicators of user actions and information associated with the actions can be stored in a persistent storage 106 as user behavior data 120.

Persistent storage 106 can store information used by the components of system 100. In addition to the user behavior data 120, persistent storage 106 can store a component library 118 of components that are available for use by, or association with, applications or components currently under development. Persistent storage 106 can also store application models 116 created by analyzer 108. Further, persistent storage 106 can store a risk catalogue 130 and a risk mitigation catalogue 132. As an example, a set of risks such as the security threats and security controls defined by NIST (described above) can be stored in risk catalogue 130. Further, a set of risk mitigations such as security controls defined by NIST can be stored as risk mitigation catalogue 132. The risk mitigation catalogue 132 can be used by user interface 122 to present a set of risk management options to a user. Although shown as one unit in FIG. 1, persistent storage 106 may include multiple persistent storage units, and the application models 116, component library 118 user behavior data 120, risk catalogue 130 and risk mitigation catalogue 132 may be distributed across the multiple persistent storage units.

Analyzer 108 can receive information from persistent storage unit 106 and use the information to generate one or more models. In some aspects, the models can include an application model 116, user choices model 112, and/or user behavior model 114. These models can be used to predict risks and risk mitigations for components. Analyzer 108 can include a machine learning engine 124 that can receive information about an application model 116 and user behavior data 120 to generate a user choices model 112. The user choices model 112 can include data that indicates the choices a user has made with respect to risks associated with the components from component library 118 that are included in an application, and risk mitigations associated with the risks. The data in user choices model 112 can define relationships between components, risks, and risk mitigations. Further, analyzer 108 can include a process mining engine 126 to generate a user behavior model 114. In some aspects, analyzer 108 can incorporate timestamp data or development phase data into models 112 and 114. The timestamp data or development phase data can be considered when providing predictions of risks and suggestions of risk mitigations.

Predictor 110 can receive data from analyzer 108 and use the data to generate a prediction for a component, including a component under development by a user. As an example, predictor 110 can receive a user choices model 112 that indicates the past choices that developers have made with respect to risks and risk mitigations for previously developed application components. The predictor 110 can then provide the generated prediction to a software developer via the user interface 122.

In some aspects, system 100 can include a deviation detector 128. Deviation detector 128 can analyze an application and its respective components and determine whether the risks and risk mitigations for the components of the application include any deviations from risks and risk mitigations associated with similar components of other previously developed applications. The deviation detector can provide a report of any detected deviations via the user interface 122.

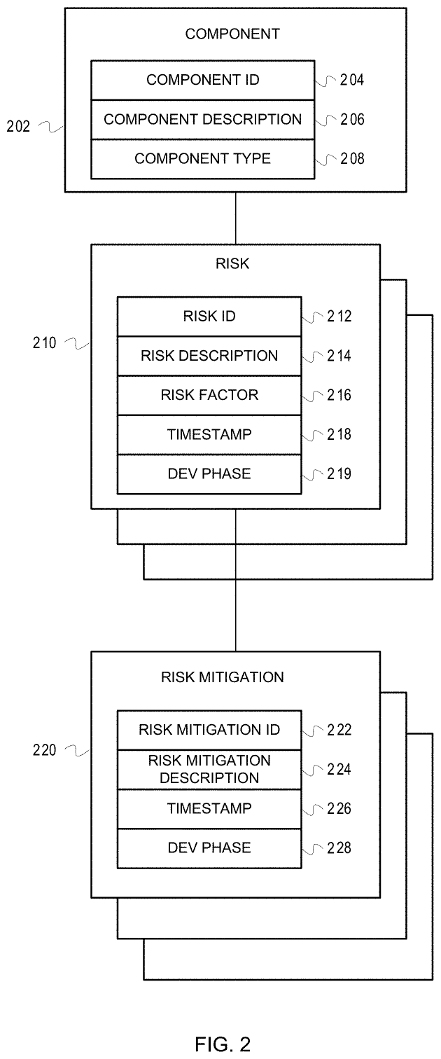

FIG. 2 is a block diagram illustrating data objects and linkages between data objects in a system for application risk management. In some aspects, the data objects can include a component data object 202, a risk data object 210, and a risk mitigation data object 220.

The component data object 202 can include data elements describing an application component. As used herein, a component of an application can include software components as well as elements that are not software, but provide information about an application. For example, a component can describe features of an application. One example of such a component is a “user story” as commonly used in Agile software development environments. A user story can be a component that provides a description of a software feature from the perspective of an end-user. As an example, a user story may be text that states “As a user, I can indicate folders not to backup so my backup drive isn't filled with files I don't need saved.” A further example of a non-software component can be an element that lists or describes features of an application.

The component data object 202 can include a component identifier (ID) 204, a component description 206, and a component type 208. The component ID 204 can be a name of a component. The component description 206 can include text describing the functionality or other aspects of the component. For software components, the component description can include descriptions of any inputs and outputs of the component. The component type 208 provides a type associated with the component. For example, the component type may indicate that the component is a web service component, a database component, a user interface component, a queuing component, logging component, authentication component, group policy component, auditing component, a user story, a feature list etc. Those of skill in the art having the benefit of the disclosure will appreciate that the a component type can be associated with any component that carries out application logic or describes features and uses of an application.

A risk data object 210 can include data elements describing a risk that can be associated with an application component data object 202. In some aspects, the risk can be a security threat. In alternative aspects, the risk can be a financial risk, a legal compliance risk, a reputational risk, a performance risk, or a resource usage risk. The inventive subject matter is not limited to any particular type of risk. The risk data object 210 can include a risk ID 212, a risk description 214, a risk factor 216, a timestamp 218, and a development phase 219. The risk ID 212 is a label identifying the risk data object 210. The label can be a name of the risk or other identifying label associated with a risk. Risk description 214 can be text describing the risk. Risk factor 216 can be a calculated risk assessment associated with the risk. In some aspects, the risk factor 216 can be calculated based on a likelihood that the risk will occur and an impact that the risk has should it occur. For example, the risk factor 216 value can be calculated according to the formula:

Risk Factor=Likelihood*Impact

The values for likelihood and the impact can be based on values assigned by one or more users of the system. Development phase 219 identifies the development phase that a component was in when the risk was associated with the component. Development phase 219 can be a label for a development phase associated with the component. For example, a development phase for a component can be analysis, design, development, testing or deployment. Timestamp 218 can be a timestamp indicating the date and time that the risk was associated with the component. In some aspects, the development phase can be derived from timestamp 218.

Risk mitigation data object 220 can include data elements describing a risk mitigation that is applied to mitigate an associated risk. As an example, in aspects where the risk is a security threat, the risk mitigation can be a security control associated with the risk. The risk mitigation data object 220 can include a risk mitigation ID 222, a risk mitigation description 224, a timestamp 226 and a development phase 228. Risk mitigation ID 222 is a label assigned to the risk mitigation. The label can be a label defined by a framework such as the NIST Cybersecurity Framework. The risk mitigation description 224 can be text describing aspects of the risk mitigation. Development phase 228 identifies the development phase that a component was in when the risk mitigation was associated with the risk. Timestamp 226 can be a timestamp indicating the date and time that the risk mitigation was associated with the risk. In some aspects, development phase 228 can be derived from timestamp 226.

It should be noted that the component data object 202, the risk data object 210, and the risk mitigation data object 220 can include other data elements that have not been shown in FIG. 2 in order to avoid obfuscating the inventive subject matter.

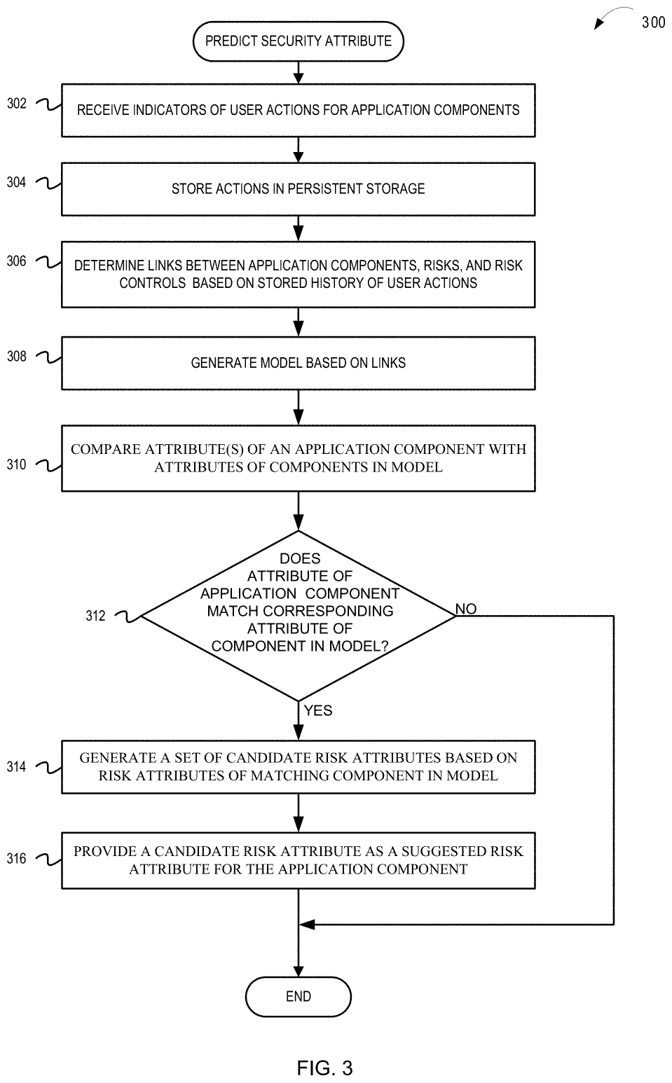

FIG. 3 is a flow chart 300 illustrating operations of a method for application risk management. At block 302, an application risk management system receives indicators of user actions for application components. As an example, a software developer may use user interface 122 to develop application components and assemble various application components into an application. Further, a software developer may use user interface 122 to associate a risk with an application component. In addition, the software developer may use user interface 122 to associate a risk mitigation with a risk. The associations can be made at any point in an application's life cycle. For instance, the association may be made while the component is under development, during testing of a completed application, or after deployment of an application. The association of a risk mitigation with a risk does not necessarily occur at the same time the risk is associated with an application component. The user interface can track the user actions used to associate risks with application components and user actions used to associate risk mitigations with risks.

In some aspects, the indicators of user actions can include indications of inputs provided at development process steps (e.g. component type, description etc.), changes in the chosen set of risk characteristics and mitigation actions associated with an application component (e.g., risks and risk mitigations), and timestamps associated with the actions.

At block 304, the system can store the indicators of user actions in a persistent storage.

At block 306, an application risk management system can determine links between application components, risks, and risk mitigations based on the stored history of user actions in the persistent storage. In some aspects, the risks and risk mitigations can be those defined by a risk catalogue and risk mitigation catalogue.

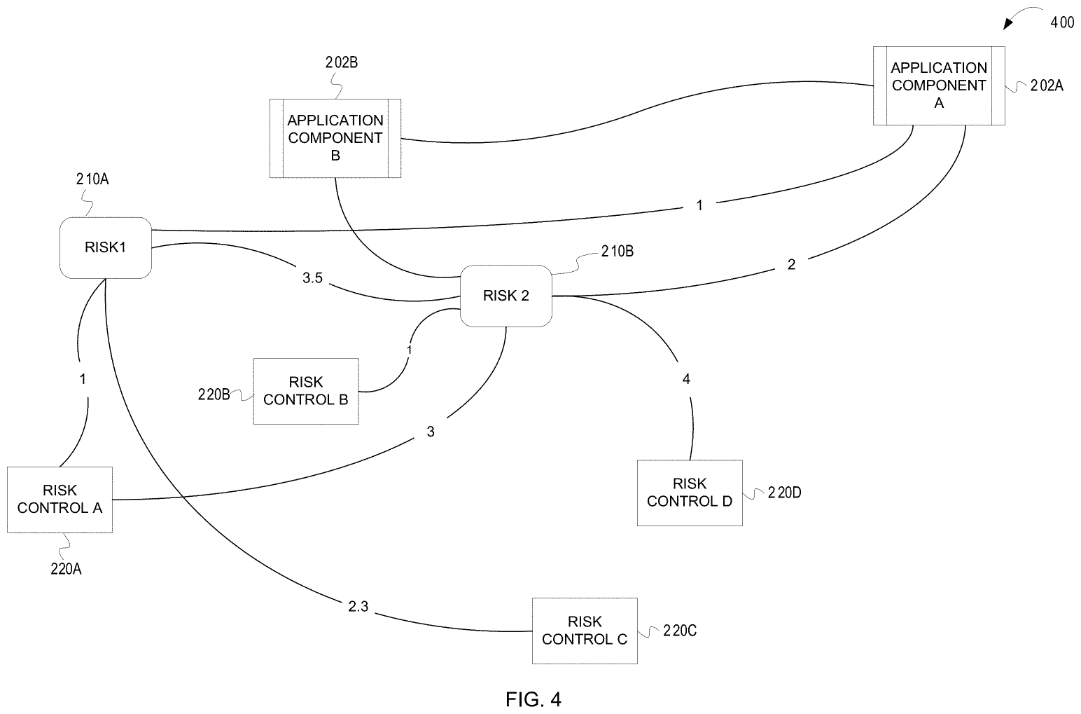

At block 308, an analyzer of an application risk management system can generate a model based on the links between application components, risks, and risk mitigations. In some aspects, the model can be a user choices model that includes data linking the components of an application, linking risks with the components, and linking risk mitigations with the risks. Thus, the model represents the components used by applications, the risks associated with the components, and any risk mitigation actions associated with the risks. The analyzer can assign values to the links between the components, risks, and risk mitigations. For instance, the analyzer can determine the number of times a particular component is used with another component in applications. The greater the number of times a component is used with the other component, the higher the value of the link. Similarly, the analyzer can determine the number of times a particular risk has been associated with a component by application developers. The value of the link between the component and the risk can be determined based on the number of times the risk was associated with the application component. Likewise, the value of a link between a risk and a risk mitigation can be based on the number of times the risk mitigation was applied to the risk. An example user choices model is presented below in FIG. 4.

In alternative aspects, the model can be a user behavior model that is created via process mining. The process mining can use the timestamps and/or development phases associated with risks and risk mitigations to represent how and when in the development process users have used the application risk management system to associate risks with components and how and when risk mitigations were associated with the risks.

At block 310, the application risk management system can compare the attributes of an application component being accessed by a developer with attributes of applications components in the model determined at block 308. The application component can be a component under development, under testing, or deployed. As an example, the application risk management system can compare the application component type of a component under development with types associated with application components in a user choices model. Further, the application risk management system can compare a description of the component under development with descriptions of components in the user choices model. Also, the application risk management system can compare the components associated with the component under development with components associated in the model.

At decision block 312, the application risk management system determines if the application component is a match to an application component in the model. For example, a match may be determined to occur if the components' types match. Further, the components may be determined to be a match if the components' descriptions match to a sufficient degree. If the components do not match, then the method ends.

If the components do match, then at block 314, the application risk management system generates a set of risks based on the risks associated with the matching component or components in the model.

At block 316, a predictor of the application risk management system can provide one or more of the generated set of risks to a developer as suggested risks for the component being accessed by the developer. The suggested risks can be based on the values of the links between the matching component in the model and its associated risks. Similarly, the predictor can provide suggested risk mitigations for the risks based on the values of the links between the risks of the matching application component in the model and the risk mitigations associated with the risks. Further, the predictor can provide suggested risks and risk mitigations based on the likelihood and severity (as determined via the risk factor). The predictor can provide the suggested risks and risk mitigations via a user interface 122 (FIG. 1) of the application risk management system.

In some aspects, a development phase or timestamp can be used to determine when a risk or risk mitigation is suggested to a user. For example, the analyzer can determine when in the development process a particular risk or risk mitigation was previously associated with a component. The risk or risk mitigation can be suggested to a user when the component that the user is working on is at the same development phase or at a similar time in development as the matching component.

FIG. 4 is a diagram illustrating an example user choices model 400. In some aspects, the user choices model 400 can be produced by a machine learning engine. Example user choices model 400 includes an application component A 202A, application component B 202B, risks 1 and 2 (210A, 210B) and risk mitigations A-D (220A, 220B, 220C and 220D). As shown in FIG. 4, application component A 202A is used with application component B 202B in various applications. Additionally, application component A 202A is associated with risk 1 210A and risk 2 210B, while application component B is associated with risk 2 210B. Risk 1 210A is associated with risk mitigation A 220A and risk mitigation C 220C, while risk 2 210B is associated with risk mitigation A 220A, risk mitigation B 220B and risk mitigation D 220D. Further, risk 1 210A and risk 2 210B are linked, indicating that when risk 1 is present, risk 2 may also be present. The values in the links indicate how often the associations exist in applications analyzed by the risk analysis system. The values may also be based on a risk assessment factor determined as indicated above. Thus, in the example illustrated in FIG. 4, risk 2 210B is more likely to be associated with an application component that matches the attributes of application component A than risk 1, as indicated by their relative link values. Similarly, risk mitigation D 220D (link value=4) is more likely to be applied to a risk 2 210B than either risk mitigation B 220B (link value=1) or risk mitigation A 220A (link value=3).

Thus, as can be seen from the user choices model, the system can determine:
which components are usually used together
which risks are more usually connected with each component type.
which mitigation actions are more usually connected with each risk.

Those of skill in the art having the benefit of the disclosure will appreciate that a typical user choices model can have many more application components, risks, and risk mitigations than those illustrated in FIG. 4.

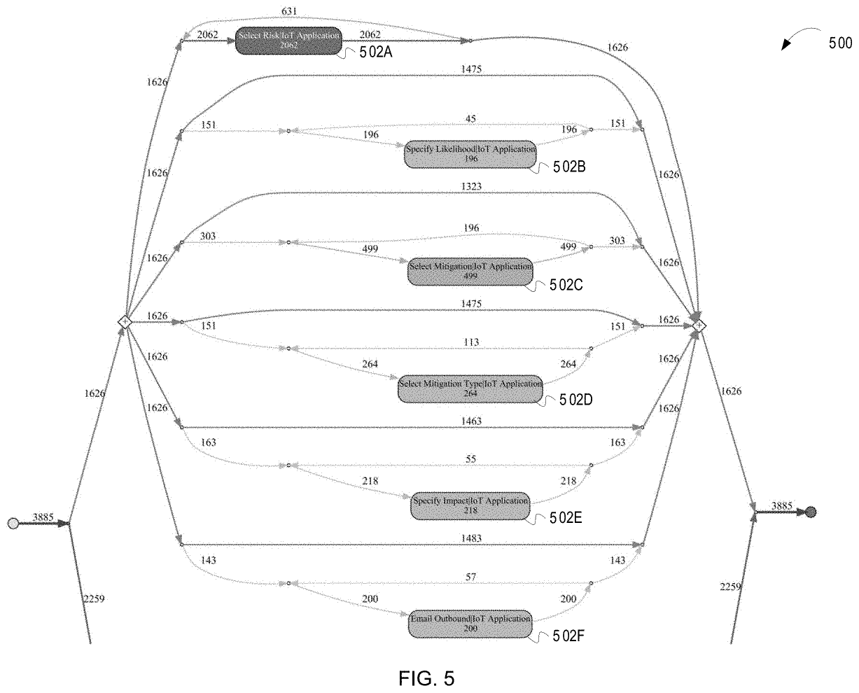

FIG. 5 is a diagram illustrating a process mining graph that represents an example user behavior model 500. In some aspects, the user behavior model can be produced by a process mining engine. Nodes 502A-502F in the graph represent actions performed by a user with respect to development of an application. In some aspects, the numbers associated with the links in the graph represent the number of times a user followed the path associated with the link. In the example illustrated in FIG. 5, 1626 actions were recorded with respect to the development of an application named “IoT Application.” Node 502C represents an action “Select Mitigation” for the “IoT Application.” Out of the 1626 times actions were performed on the application, 1323 bypassed the “Select Mitigation” action. The “Select Mitigation” action was performed 499 times, of which 196 were reselections of a mitigation action, resulting in 303 confirmed selections of a mitigation action. In addition to the number of times an action was performed in the tool, the user behavior model can include data associated with the development phase and/or a timestamp of when the action was performed.

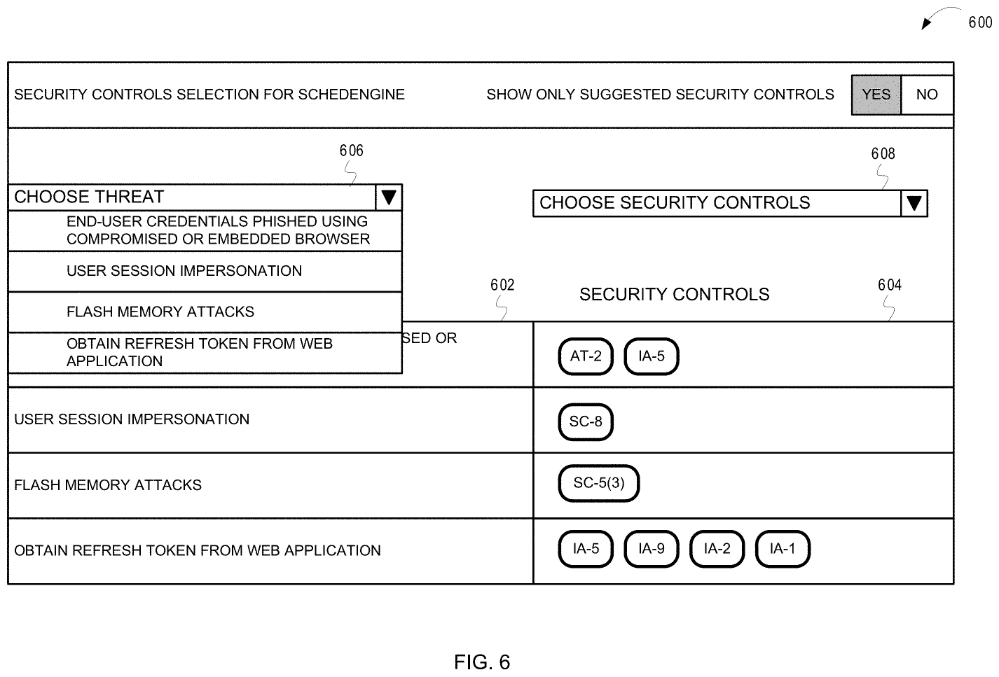

FIG. 6 illustrates an example user interface 600. The example user interface illustrates a user interface for performing risk assessment of an application component called “SchedEngine,” where the risks are NIST risks and the risk mitigations are NIST security controls. The example user interface 600 includes a risk column 602 that shows the risks associated with the SchedEngine component. The security controls associated with the corresponding risks are shown in security control column 604. A dropdown 606 provides suggested risks to add to the SchedEngine component that have been suggested by a predictor of an application risk management system. A developer can select a suggested risk to add to the SchedEngine component using drop down 606. A developer can select a suggested security control using drop down 608 to provide a list of suggested security controls to use for a risk. Those of skill in the art having the benefit of the disclosure will appreciate that other user interface elements may be used to select from suggested risks and risk mitigations.

Variations

As described above, a predictor can be used along with application component models to provide a prediction to a software developer as to the risks and risk mitigations that the software developer may desire to apply to an application component. In further aspects, the above-described application risk assessment system can be used determine deviations in risks and risk mitigations from that predicted by a model. For example, a deviation detector 128 (FIG. 1) can compare the risks and risk mitigations used by the components of an application with the risks and risk mitigations used by similar components in the model to determine how the application deviates from the model. The deviations in risks and risk mitigations can be reported to a developer, who can use the report to determine any desired changes to the risks and risk mitigations for the application.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

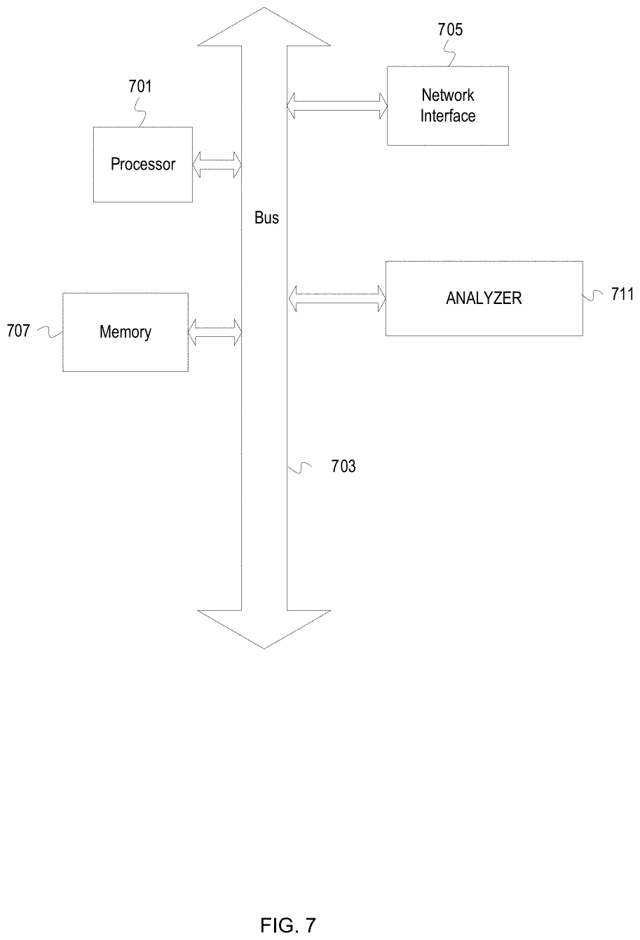

FIG. 7 depicts an example computer system for application risk management. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes an analyzer 711. The analyzer 711 can analyze application risks in accordance with any of the methods and components described herein. Any one of the previously described functionalities may be partially (or entirely) implemented in hardware and/or on the processor unit 701. For example, the functionality may be implemented with an application specific integrated circuit, in logic implemented in the processor unit 701, logic executed by the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for application risk management as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method for managing application risks, the method comprising:
receiving indicators of user actions associated with risks for a plurality of application components;
storing the indicators of the user actions in a history of indicators of user actions, the history of indicators of user actions associated with a plurality of component data objects representing the plurality of application components and a plurality of risk data objects representing the risks;
determining links between the plurality of component data objects and the risk data objects based, at least in part, on the history of indicators of user actions;
comparing an attribute of an application component with attributes of the plurality of component data objects; and
determining, based at least in part on the comparison and the links between the plurality of component data objects and the risk data objects, a suggested risk for the application component.

2. The method of claim 1, further comprising:
determining a risk factor of a risk data object based, at least in part, on a likelihood associated with a risk represented by the risk data object and a severity value associated with the risk;
wherein said determining, based at least in part on the comparison and the links between the plurality of component data objects and the risk data objects, the suggested risk for the application component comprises determining the suggested risk based, at least in part, on the risk factor of the risk data object associated with the suggested risk.

3. The method of claim 1, further comprising:
determining strength values for the links between the component data objects and the risk data objects based, at least in part, on the history of indicators of user actions;
wherein said determining, based at least in part on the history of indicators of user actions, the suggested risk for the application component comprises determining the suggested risk based, at least in part on the strength values.

4. The method of claim 3, wherein said determining the strength values for the links between the component data objects and the risk data objects comprises determining a strength value of a link between a component data object and a risk data object based, at least in part, on a number of times a risk represented by the risk data object is associated with an application component represented by the component data object.

5. The method of claim 1, further comprising:
maintaining a history of indicators of user actions associated with a plurality of risk mitigation data objects;
determining links between the risk data objects and the risk mitigation data objects based, at least in part, on the history of indicators of user actions; and
determining, based at least in part on the history of indicators of user actions, a suggested risk mitigation for the application component.

6. The method of claim 5, further comprising:
determining strength values for the links between the risk data objects and the risk mitigation data objects based, at least in part, on the history of indicators of user actions;
wherein said determining, based at least in part on the history of indicators of user actions, the suggested risk mitigation for the application component comprises determining the suggested risk mitigation based, at least in part on the strength values.

7. The method of claim 6, wherein a strength value of a link between a risk data object and a risk mitigation data object is determined, based at least in part, on a number of times a risk mitigation represented by the risk mitigation data object is associated with a risk represented by the risk data object.

8. The method of claim 1, further comprising:
determining links between the plurality of component data objects representing application components, wherein a link between a first component data object and a second component data object indicates that a first application component represented by the first component data object is used with a second application component represented by the second component data object.

9. The method of claim 8, further comprising:
determining strength values for the links between the plurality of component data objects, wherein a strength value of a link between a first component data object and a second component data object is determined, based at least in part, on a number of times the first application component is used with the second application component;
wherein said determining, based at least in part on the history of indicators of user actions, the suggested risk for the application component comprises determining the suggested risk based, at least in part on the strength values.

10. The method of claim 1, further comprising:
updating the history of indicators of user actions in response to receiving a new indicator of user activity for the application component; and
determining, based at least in part on the updated history of indicators of user actions, at least one of a second suggested risk or a second suggested risk mitigation for the application component.

11. One or more non-transitory machine-readable media comprising program code for managing application risks, the program code comprising instructions to:
maintain a plurality of component data objects representing application components and a plurality of risk data objects;
maintain a history of indicators of user actions associated with the plurality of component data objects and the plurality of risk data objects;
determine links between the component data objects and the risk data objects based, at least in part, on the history of indicators of user actions;
generate a model based, at least in part, on the links between the component data objects and the risk data objects;
compare an attribute of a component data object for an application component with attributes of the plurality of component data objects; and
determine, based at least in part on the comparison and the model, a suggested risk for the application component.

12. The one or more non-transitory machine-readable media of claim 11, wherein the program code further comprises instructions to:
determine a risk factor for a risk data object based, at least in part, on a likelihood associated with a risk represented by the risk data object and a severity value associated with the risk;
wherein the instructions to determine, based at least in part on the model, the suggested risk for the application component comprise instructions to determine the suggested risk based, at least in part, on the risk factor for the risk data object associated with the suggested risk.

13. The one or more non-transitory machine-readable media of claim 11, wherein the program code further comprises instructions to:
determine strength values for the links between the component data objects and the risk data objects based, at least in part, on the history of indicators of user actions;
wherein the instructions to determine, based at least in part on the model, the suggested risk for the application component comprise instructions to determine the suggested risk based, at least in part on the strength values.

14. The one or more non-transitory machine-readable media of claim 13, wherein the instructions to determine the strength values for the links between the component data objects and the risk data objects comprise instructions to determine a strength value of a link between a component data object and a risk data object based, at least in part, on a number of times a risk represented by the risk data object is associated with an application component represented by the component data object.

15. The one or more non-transitory machine-readable media of claim 11, wherein the program code further comprises instructions to:
maintain a history of user actions associated with a plurality of risk mitigation data objects;
determine links between the risk data objects and the risk mitigation data objects based, at least in part, on the history of indicators of user actions, wherein the instructions to generate the model further comprise instructions to generate the model based, at least in part, on the links between the risk data objects and the risk mitigation data objects; and
determine, based at least in part on the model, a suggested risk mitigation for the application component.

16. An apparatus comprising:
a processor; and
a machine-readable medium comprising instructions executable by the processor to cause the apparatus to,
maintain a plurality of component data objects representing application components, a plurality of risk data objects and a plurality of risk mitigation data objects;
maintain a history of indicators of user actions associated with the plurality of component data objects, the plurality of risk data objects, and the plurality of risk mitigation data objects;
determine links between the component data objects and the risk data objects and links between the risk data objects and the risk mitigation data objects based, at least in part, on the history of indicators of user actions;
generate a model based, at least in part, on the links between the component data objects and the risk data objects and the links between the risk data objects and the risk mitigation data objects; and
determine, based at least in part on the model, a suggested risk for an application component.

17. The apparatus of claim 16, wherein the instructions further comprise instructions to:
determine a risk factor for a risk data object based, at least in part, on a likelihood associated with a risk represented by the risk data object and a severity value associated with the risk;
wherein the instructions to determine, based at least in part on the model, the suggested risk for the application component comprise instructions to determine the suggested risk based, at least in part, on the risk factor for the risk data object associated with the suggested risk.

18. The apparatus of claim 16, wherein the instructions further comprise instructions to:
determine, based at least in part on the model, a suggested risk mitigation for the application component.

19. The apparatus of claim 16, wherein the instructions further comprise instructions to:
determine links between the plurality of component data objects representing application components, wherein a link between a first component data object and a second component data object indicates that a first application component represented by the first component data object is used with a second application component represented by the second component data object;
wherein the instructions to generate the model based, at least in part, on the links between the component data objects and the risk data objects and the links between the risk data objects and the risk mitigation data objects further comprise instructions to generate the model based, at least in part, on the links between the plurality of component data objects.

20. The apparatus of claim 19, wherein the instructions further comprise instructions to:
determine strength values for the links between the plurality of component data objects, wherein a strength value of a link between a first component data object and a second component data object is determined, based at least in part, on a number of times the first application component is used with the second application component.
